(19) United States
(12) Patent Application Publication
(10) Pub. No.: US 2025/0363419 A1
(43) Pub. Date: Nov. 27, 2025

(54) METHOD AND SYSTEM FOR FEATURE MODEL BASED INTEGRATION OF MACHINE LEARNING COMPONENTS IN SOFTWARE PRODUCTS

(71) Applicant: Tata Consultancy Services Limited, Mumbai (IN)

(72) Inventors: Deepali Dinanath Prabhu KHOLKAR, Pune (IN); Suraj THAPA, Pune (IN); Akhilesh Kumar PAL, Pune (IN); Suman ROYCHOUDHURY, Pune (IN)

(73) Assignee: Tata Consultancy Services Limited, Mumbai (IN)

(21) Appl. No.: 19/215,460

(22) Filed: May 22, 2025

(30) Foreign Application Priority Data
May 27, 2024 (IN) 202421041021

(51) Int. Cl. G06N 20/00

(52) U.S. Cl. CPC G06N 20/00

(57) ABSTRACT

This disclosure relates generally to a system and method for feature model-based integration of machine learning (ML) components in software products. Currently, formulation of ML solution and integrating it into a software product is performed by ML experts. The present disclosure provides a framework for automating ML development and integration into the software product. The method utilizes a product feature model and a ML meta-model to specify integration of ML capabilities into the software product. The disclosed method integrates various steps in the ML development process such as mapping of the business use case as an ML problem, pre-processing raw data, identifying metrics to measure model performance, defining training and test data sets, training multiple ML models, tuning their parameters and making predictions on test data, to the software product. Dependency relationships are mapped between learning features and product features for including necessary features of the software product configurations.

### PRIORITY CLAIM

This U.S. patent application claims priority under 35 U.S.C. § 119 to: Indian patent application Ser. No. 20/242,1041021, filed on 27 May 2024. The entire contents of the aforementioned application are incorporated herein by reference.

### TECHNICAL FIELD

The disclosure herein generally relates to integration of machine learning components, and, more particularly, to a method and system for feature model-based integration of machine learning components in software products.

### BACKGROUND

Machine learning (ML) techniques are finding critical application in almost every area of operation of modern businesses to analyze and gather insights from the vast amounts of data available with enterprise systems for informed decision making, prediction and forecasting. Software product vendors now need to integrate a growing number of ML components in their products in order to extend data analysis capabilities to their users.

Integration with software products requires the development, deployment, and configuration of ML components to be managed as part of the product engineering and configuration life-cycle. In addition to software engineering (SE), the integration process also needs to address the key ML concerns of engineering data pipelines, model design and tuning, and model monitoring for each ML component being integrated into the product.

Integrated software engineering of ML components has not received much attention in the literature. Currently design and development of ML components occurs in a standalone manner from software products and systems. Each step in formulation of the ML solution such as data curation and pre-processing, feature extraction, choice of algorithm, coding, model tuning, and monitoring is carried out by ML experts since these skills are not available with most software development teams. Furthermore black-box integration of ML components into software systems gives development teams no control on processing encoded in the component. Few prior works modify ML code already deployed in a software system using a specification to describe the changes required, generate the changed ML code and deploy it in the software system to replace earlier code. Another prior work scans deployed ML code for giving programmers a view of the code structure. Reducing the complexity in building ML solutions and integrating their development with product engineering processes is necessary to facilitate greater participation of product development teams and speed up implementation.

### SUMMARY

Embodiments of the present disclosure present technological improvements as solutions to one or more of the above-mentioned technical problems recognized by the inventors in conventional systems. For example, in one embodiment, a method for feature model-based integration of machine learning components in software products is provided. The method includes receiving a set of machine learning (ML) model requirements for solving a ML problem associated with a software product defined using a product feature model. The set of ML model requirements includes a set of input data features, a set of output data features, and a containing feature from the product feature model. Further, the method includes, creating a set of dependencies between the set of ML model requirements and the plurality of product features encapsulated into a learning feature to be associated with a ML meta-model. Furthermore, the method includes, creating one or more ML model instances utilizing the ML meta-model comprising a set of techniques for each step amongst a set of steps of an ML process. Further, the method includes, generating one or more ML software codes utilizing the one or more ML model instances. Furthermore, the method includes, generating one or more training application programming interfaces (APIs) and one or more prediction APIs for calling the one or more ML software codes using an API generation tool. Further, the method includes, extracting an input data associated with the set of input data features and an output data associated with the set of output data features from a plurality of data sources corresponding to the software product. The method also includes generating one or more ML models by performing a training process and a testing process, utilizing the one or more training application programming interfaces (APIs), the input data and the output data. Further, the method includes, obtaining a final ML model from the one or more ML models by comparing the performance metric score of each ML model. Finally, the method includes, integrating the final ML model with the software product by inserting a prediction API associated with the final ML model.

In another aspect, a system for feature model-based integration of machine learning components in software products is provided. The system comprises memory storing instructions; one or more communication interfaces; and one or more hardware processors coupled to the memory via the one or more communication interfaces, wherein the one or more hardware processors are configured by the instructions to receive a set of machine learning (ML) model requirements for solving a ML problem associated with a software product defined using a product feature model. The set of ML model requirements includes a set of input data features, a set of output data features, and a containing feature from the product feature model. Further, the system includes, creating a set of dependencies between the set of ML model requirements and the plurality of product features encapsulated into a learning feature to be associated with a ML meta-model. Furthermore, the system includes, creating one or more ML model instances utilizing the ML meta-model comprising a set of techniques for each step amongst a set of steps of an ML process. Further, the system includes, generating one or more ML software codes utilizing the one or more ML model instances. Furthermore, the system includes, generating one or more training application programming interfaces (APIs) and one or more prediction APIs for calling the one or more ML software codes using an API generation tool. Further, the system includes, extracting an input data associated with the set of input data features and an output data associated with the set of output data features from a plurality of data sources corresponding to the software product. The system also includes generating one or more ML models by performing a training process and a testing process, utilizing the one or more training application programming interfaces (APIs), the input data and the output data. Further, the system includes, obtaining a final ML model from the one or more ML models by comparing the performance metric score of each ML model. Finally, the system includes, integrating the final ML model with the software product by inserting a prediction API associated with the final ML model.

The product feature model captures a plurality of functions of the software product as a plurality of product features. the set of dependencies are dynamically updated during at least one of (i) updates in the set of ML model requirements, and (ii) updates in the plurality of product features. The set of dependencies are used to validate the set of ML model requirements and the plurality of product features during configuration of the software product. The containing feature comprises deployment data for the learning feature providing at least one product feature amongst the plurality of product features where the final ML model is to be deployed. The fixed data includes a set of import libraries comprising pandas, numpy, scikit-learn and code for pre-processing and the variable data includes data from the one or more ML model instances.

In yet another aspect, there is provided a computer program product comprising a non-transitory computer readable medium having a computer readable program embodied therein, wherein the computer readable program, when executed on a computing device causes the computing device for feature model-based integration of machine learning components in software products by receiving a set of machine learning (ML) model requirements for solving a ML problem associated with a software product defined using a product feature model. The set of ML model requirements includes a set of input data features, a set of output data features, and a containing feature from the product feature model. Further, the computer readable program includes, creating a set of dependencies between the set of ML model requirements and the plurality of product features encapsulated into a learning feature to be associated with a ML meta-model. Furthermore, the computer readable program includes, creating one or more ML model instances utilizing the ML meta-model comprising a set of techniques for each step amongst a set of steps of an ML process. Further, the computer readable program includes, generating one or more ML software codes utilizing the one or more ML model instances. Furthermore, the computer readable program includes, generating one or more training application programming interfaces (APIs) and one or more prediction APIs for calling the one or more ML software codes using an API generation tool. Further, the computer readable program includes, extracting an input data associated with the set of input data features and an output data associated with the set of output data features from a plurality of data sources corresponding to the software product. The computer readable program also includes generating one or more ML models by performing a training process and a testing process, utilizing the one or more training application programming interfaces (APIs), the input data and the output data. Further, the computer readable program includes, obtaining a final ML model from the one or more ML models by comparing the performance metric score of each ML model. Finally, the computer readable program includes, integrating the final ML model with the software product by inserting a prediction API associated with the final ML model.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of a system for feature model-based integration of machine learning components in software product according to some embodiments of the present disclosure.

FIG. 2 is a functional block diagram of the system for feature model-based integration of machine learning components in the software product in accordance with some embodiments of the present disclosure.

FIG. 3 is an exemplary flow diagram illustrating a method for feature model-based integration of machine learning components in the software product according to some embodiments of the present disclosure.

FIG. 4 illustrates a product feature model corresponding to the software product according to some embodiments of the present disclosure.

FIG. 5 illustrates a machine learning meta-model utilized to integrate machine learning components in the software product according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Development of machine learning (ML) components is complex and requires ML expertise not available with most product teams. ML components are developed separately and integrated as black-boxes which makes its configuration management and maintenance as part of the software products hard. There is high demand for data analysis using artificial intelligence (AI)/ML for critical decision-making in every business vertical. Data analysis features need to be incorporated into software products used by business enterprises.

The present disclosure provides a method and framework for automating a large part of ML development and integration into software products. The disclosed method provides a means for development teams with limited knowledge of ML to specify ML requirements by simply selecting from a pre-modeled process and options for algorithms and their parameters for each process step. This specification is used to auto-generate ML code, train and test an ML model and integrate it into software product code. The present disclosure provides a model-based architecture and framework that uses a feature model to specify integration of ML capabilities seamlessly into a target product architecture and automatically generates an ML implementation from a modeled specification. The disclosed method integrates steps in the ML development process such as mapping of the business use case as an ML problem, pre-processing raw data, identifying metrics to measure model performance, defining training and test data sets, training multiple ML models, tuning their parameters and making predictions on test data.

The present disclosure addresses technical challenges posed during integration of ML with software products. Such as a software engineering (SE) process for ML to enable faster development and seamless integration with software systems, capturing dependencies of product features on ML components and vice versa to facilitate integrated configuration management. The phrase software product may be interchangeably used as product herein after. Similarly, the phrase product feature model and feature model are used interchangeably throughout the description.

Feature models capture details of product line functionality and possible variations in the form of a simple hierarchical model of features. Each feature denotes a characteristic of the problem space. A feature model captures commonality and variability aspects of the product line i.e., common features that exist in every product variant and variable features whose choices define a configuration. Product variants are specified in terms of mandatory features, selection from a set of optional features, at least one among ORed features and exactly one from among alternate or XORed features. A product configuration is created by selecting from available features and their variants. Feature models are a representation closer to the problem domain that stakeholders can easily understand and use to select product configurations. In order to use feature models for model-driven development (MDD), details necessary for implementation in object-oriented code are additionally annotated on the feature models.

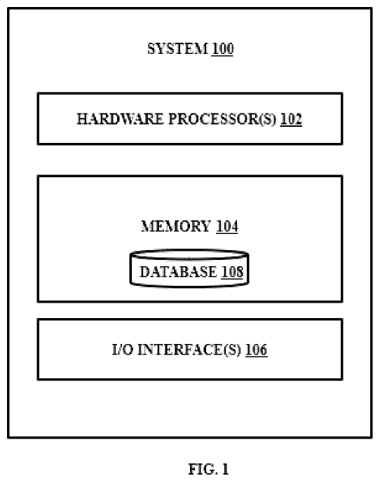

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 illustrates an exemplary block diagram of a system 100 configured for feature model-based integration of machine learning components in software product according to some embodiments of the present disclosure. In an embodiment, the system 100 includes one or more hardware processors 102, communication interface(s) or input/output (I/O) interface(s) 106, and one or more data storage devices or memory 104 operatively coupled to the one or more processors 102. The one or more hardware processors 102 that are hardware processors can be implemented as one or more microprocessors, microcomputers, microcontrollers, digital signal processors, central processing units, state machines, graphics controllers, logic circuitries, and/or any devices that manipulate signals based on operational instructions. Among other capabilities, the processor(s) are configured to fetch and execute computer-readable instructions stored in the memory. In the context of the present disclosure, the expressions ‘processors’ and ‘hardware processors’ may be used interchangeably. In an embodiment, the system 100 can be implemented in a variety of computing systems, such as laptop computers, notebooks, hand-held devices, workstations, mainframe computers, servers, a network cloud and the like.

The I/O interface(s) 106 may include a variety of software and hardware interfaces, for example, a web interface, a graphical user interface, and the like and can facilitate multiple communications within a wide variety of networks and protocol types, including wired networks, for example, LAN, cable, etc., and wireless networks, such as WLAN, cellular, or satellite. In an embodiment, the I/O interface(s) can include one or more ports for connecting a number of devices to one another or to another server.

The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

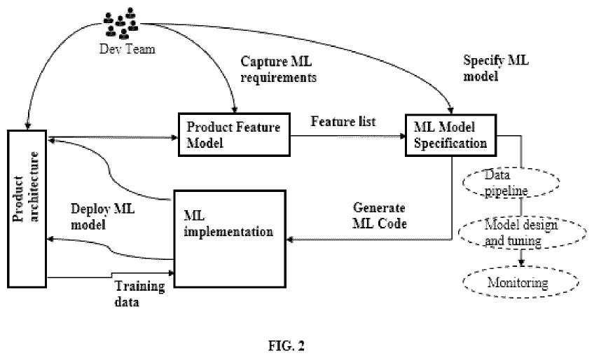

In an embodiment, the memory 104 includes a plurality of modules as depicted in FIG. 2, such as a product architecture (not shown), product feature model, ML implementation (not shown), ML model specification (not shown) and the like. Further, the plurality of modules includes programs or coded instructions that supplement applications or functions performed by the system 100 for executing different steps involved in the process for ML integration being performed by the system 100. The plurality of modules, amongst other things, can include routines, programs, objects, components, and data structures, which performs particular tasks or implement particular abstract data types. The plurality of modules may also be used as, signal processor(s), node machine(s), logic circuitries, and/or any other device or component that manipulates signals based on operational instructions. Further, the plurality of modules can be used by hardware, by computer-readable instructions executed by the one or more hardware processors 102, or by a combination thereof. The plurality of modules can include various sub-modules (not shown).

Further, the memory 104 may include a database 108 or repository. The memory 104 may comprise information pertaining to input(s)/output(s) of each step performed by the processor(s) 102 of the system 100 and methods of the present disclosure. In an embodiment, the database 108 may be external (not shown) to the system 100 and coupled via the I/O interface 106. The database may include data sources corresponding to a software product where input data and output data for training process of ML model, ML source codes and so on.

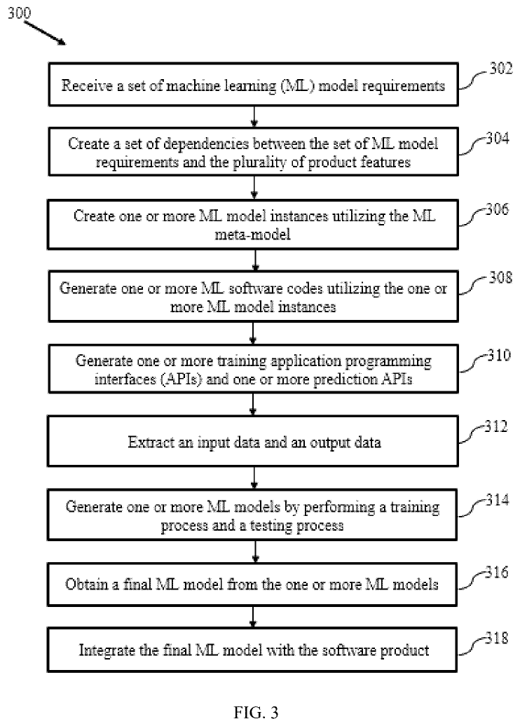

FIG. 2 is a functional block diagram of the system for feature model-based integration of machine learning components in the software product. in accordance with some embodiments of the present disclosure. As depicted in FIG. 2, software engineering of ML components is integrated with the software product in four stages such as capture ML requirements, specify ML model, generate ML model and deploy ML model. The disclosed system also supports for key ML life-cycle steps of creating the data pipeline, model experimentation, tuning, and monitoring. In an embodiment, the software product architecture is a microservice architecture with a user interface (UI) developed in Angular framework. A product feature model captures functionality of the target product as features. Features are annotated with additional details for their implementation as classes and microservices, and for orchestration of microservices in processes. Requirements for a new ML component are specified by adding it as a feature in the product feature model. This enables ML features to be available along with product features for selection as part of a product configuration. Also, this enables the ML feature integration and deployment to be managed along with other selected product features. ML features also need to be mapped into the product implementation as classes and microservices. A detailed explanation on the working of FIG. 2 is provided in FIG. 3 using steps 302 through 318.

FIG. 3 is an exemplary flow diagram illustrating a method 300 for feature model-based integration of machine learning components in software product according to some embodiments of the present disclosure. In an embodiment, the system 100 comprises one or more data storage devices or the memory 104 operatively coupled to the one or more hardware processor(s) 102 and is configured to store instructions for execution of steps of the method 300 by the processor(s) or one or more hardware processors 102. The steps of the method 300 of the present disclosure will now be explained with reference to the components or blocks of the system 100 as depicted in FIG. 1 and the steps of flow diagram as depicted in FIG. 3. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communication network. The order in which the method 300 is described is not intended to be construed as a limitation, and any number of the described method blocks can be combined in any order to implement the method 300, or an alternative method. Furthermore, the method 300 can be implemented in any suitable hardware, software, firmware, or combination thereof.

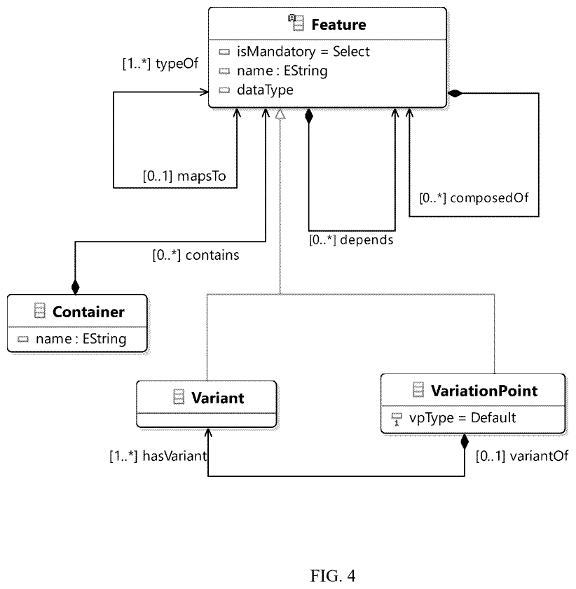

Now referring to FIG. 3, at step 302 of the method 300, one or more hardware processors are configured to receive from a user, a set of machine learning (ML) model requirements for solving a ML problem associated with a software product to generate a final ML model. The set of ML model requirements includes a set of input data features, a set of output data features, and a containing feature from the product feature model. The software product as explained before is defined using a product feature model. The product feature model captures a plurality of functions of the software product as a plurality of product features. The product feature model is depicted as in FIG. 4. The product feature model captures the plurality of product features, their composition and dependency relationships. As depicted in FIG. 4, a VariationPoint is defined to capture possible variants of a feature in the software product. Variation points can be of type OR/XOR to allow selection of at least one and exactly one variant respectively. Features are mapped to an object-oriented implementation of the software product utilizing the product feature model.

Further, at step 304 of the method 300, the one or more hardware processors are configured to create a set of dependencies between the set of ML model requirements and the plurality of product features encapsulated into a learning feature to be associated with a ML meta-model. The ML requirements for the ML problem are captured as a specialized feature termed learning feature that encapsulates input data features and output data features for ML selected as a projection over product features. Deployment details for the learning feature are captured by associating it with the containing feature within which it needs to be invoked, typically a method feature that maps to a class method. The containing feature includes deployment data for the learning feature providing at least one product feature amongst the plurality of product features where the final ML model is to be deployed. In this manner set of dependencies between the containing feature, learning feature and input-output data features are established and integration of ML component into the software product is specified. The user selects the containing feature and associates with the learning feature using the Feature→composedOf→Feature association. For each such association, the post-processor automatically creates a Feature→dependsOn→Feature association between the parent feature and the learning feature. These define dependencies of the product features on ML component. The user selects the input and output data features and associates them with the learning feature using associations LearningFeature→input→Feature and LearningFeature→output→Feature. For each of these associations, the post-processor creates a Feature→dependsOn→Feature association between the learning feature and each input and output feature. These define dependencies of the ML component on the software product features. The set of dependencies are used to validate the set of ML model requirements and the plurality of product features during configuration of the software product.

Data dependencies made explicit in the model not only automate creation of the initial data pipeline for ML but also update it to reflect changes in product feature model. Change in the product is percolated to ML components in this manner. Data is fetched afresh and the ML model may need to be retrained and retuned due to change in dimensionality or distribution of the data. In turn if there is a change in feature selection from the ML end it reflects in feature dependencies for product configuration and as change in the ML component's generated code.

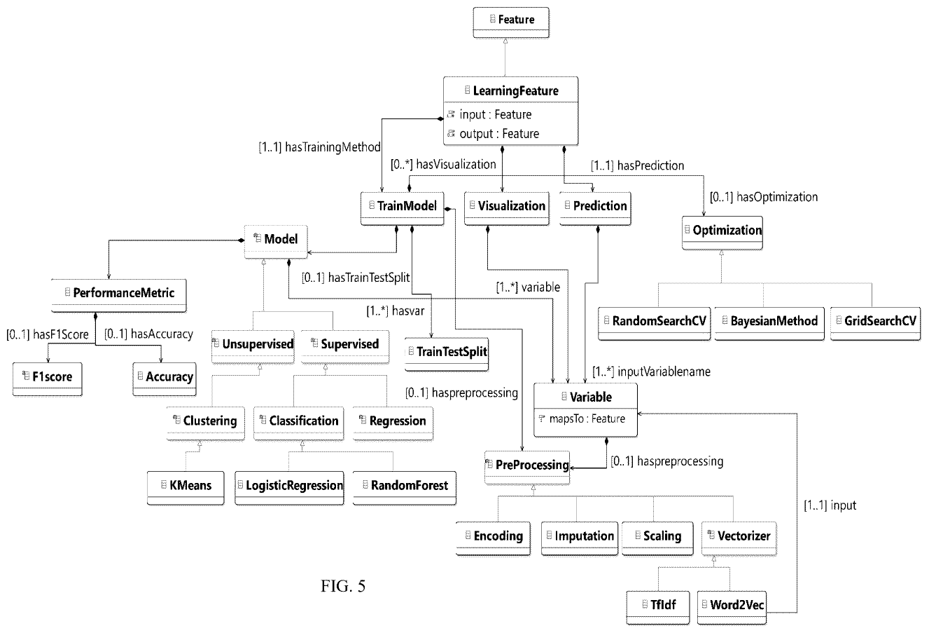

Further, at step 306 of the method 300, the one or more hardware processors are configured to create one or more ML model instances utilizing the ML meta-model as depicted in FIG. 5, comprising a set of techniques for each step amongst a set of steps of an ML process. The set of steps includes a preprocessing, a model training, a prediction, an optimization, a performance metric evaluation, and a visualization. FIG. 5 illustrates a machine learning meta-model utilized to integrate machine learning components in the software product according to some embodiments of the present disclosure. The ML meta-model defines the key elements that characterize an ML solution as a set of choices. Specifically, various ML algorithms and their hyperparameters are captured that the user need to select from in order to specify the ML model for a particular use case or problem. As shown in FIG. 5 the ML model is specified in the LearningFeature through its associated training and prediction methods TrainModel and Prediction respectively and output Visualization. TrainModel has associated inputs Model, Preprocessing, Optimization and TrainTestSplit. Model can be Supervised or Unsupervised where Supervised could be either Regression or Classification while under Unsupervised include only Clustering. Input and output data associated with the Model are mapped using Variables that are picked from the input and output data features specified in the learning feature. In an embodiment, the present disclosure uses Eclipse Ecore Modeling Framework (EMF) to define the meta-models and the EMF-generated model editor to instantiate the meta-model and create the product feature model.

The ML meta-model defines data PreProcessing methods Imputation, Duplication and Text Cleaning and Tokenizing, feature engineering techniques Encoder and Vectorizer; and hyperparameter tuning methods RandomSearchCV and GridSearchCV for which optimization method can be derived from the class Optimization. TrainTestSplit is used to split the data into train and test sets. PerformanceMetric is associated with Model to measure the performance of the ML algorithm and can be used for automated monitoring of performance. The ML meta-model can be extended further and specific methods defined by subclassing and extending any of these classes. e.g., currently ML meta-model as shown in FIG. 5, provides only for standard gensim pre-processing however the ML meta-model can be enriched by adding other pre-processing methods using natural language toolkit (NLTK) library and the like. These abstractions capture the ML process in a parameterized form enabling product development teams to participate in ML development even if they lack ML expertise. The team can instantiate the ML meta-model, make choices for ML models and hyperparameter values and use the resultant learning feature model to generate the ML code as detailed in step 308.

At step 308 of the method 300, the one or more hardware processors are configured to generate one or more ML software codes utilizing the one or more ML model instances. Each ML software code amongst the one or more ML software codes are generated using a code template comprising a fixed data and a variable data. In an embodiment of the present disclosure, the Ecore instance model comprising the learning feature with ML model specification mapped to the plurality of product features is used for generation of ML software code in Python. The one or more ML software codes in Python is generated using a textual code template that includes a fixed part and a variable part. The fixed code comprises necessary library imports such as pandas, numpy, scikit-learn and code for data pre-processing. The variable part is populated using information extracted from the ML model instance in the input XML such as encoding type, ML model, input and output variables, vectorization, and train-test split. Python code for the learning feature class is generated from the extracted ML specification using the template into a new file with proper indentation. Visualization code is similarly generated for specified data variables from the ML model instance file and executed to create visualization images.

Further at step 310 of the method 300, the one or more hardware processors are configured to generate one or more training application programming interfaces (APIs) and one or more prediction APIs using API generation specialized tools or manually writing codes. These APIs are used for calling the one or more ML software codes. The generated one or more training APIs and the one or more prediction API functions of the learning feature class take the input dataset, predict test and train accuracy, and create the image file of the data visualization.

At step 312 of the method 300, the one or more hardware processors are configured to extract a plurality of input data associated with the set of input data features and a plurality of output data associated with the set of output data features from a plurality of data sources corresponding to the software product. Variables and associated input-output features define the data pipeline for the ML component that is used to generate query code for retrieving input data from corresponding database table(s). The product feature model therefore provides control over the manipulation of input-output variables. Adding configuration conditions such as date ranges for selective data curation is possible by adding rules for the retrieval query in the model

Further at step 314 of the method 300, the one or more hardware processors are configured to generate one or more ML models by performing a training process and a testing process, utilizing the one or more training application programming interfaces (APIs), the plurality of input data and the plurality of output data. Each ML model amongst the one or more ML models is associated with a performance metric score. The training API invokes the method TrainModel that takes input data features and uses the captured encoding, vectorization and train-test-split information to pre-process the data and split into train and test sets. The train-test sets are fed to the ML model that uses its fit and predict methods to train and test the model, then measure the train and test performance with specified PerformanceMetric and send the result to the front-end service from where the API has been invoked. Visualization of the result is problem specific e.g., confusion matrix is a one way to visualize classification, regression results can be shown as regression line plot, while clustering results can be visualized by plotting data points with centroid. The one or more prediction API invokes Prediction (keyValPair) method of class learning feature that takes key-value pairs of attributes used in model training and their corresponding values and gives a prediction of the target variable or cluster.

Further at step 316 of the method 300, the one or more hardware processors are configured to obtain a final ML model from the one or more ML models. The final ML model is obtained by comparing the performance metric score of each ML model. The ML model with highest performance metric is considered to be the final ML model. The comparison may be automated or manual. Experimentation with multiple ML models is facilitated by specifying desired models as explained before. Specified performance metrics are calculated during training and testing of the model. Hyperparameters need to be tuned after observing model performance. The model provides a view of hyperparameter search space making it easier for the product development team to tune ML models than manipulating code. Performance of various models is compared and the model with best performance is chosen. For monitoring performance of the deployed model over time, ML model versions can be saved each time the model is trained along with corresponding specification models containing hyperparameter settings and performance metrics. Model versions can be retrieved for predictions on a test set and the results used to derive insights into tuning and optimization needed.

Finally, at step 318 of the method 300, the one or more hardware processors are configured to integrate the final ML model with the software product by inserting a prediction API associated with the final ML model, wherein the prediction API is within the containing feature.

EXPERMENTAL RESULTS: The example problem considered is classification of tickets raised by users of the telecom product and its services. Users raise tickets by entering a textual description of their problem based on which customer support teams manually classify tickets by associating the following three tags to the problem description
1) Category this problem falls into which is basically Complaint or Request
2) Type of problem within the assigned category
3) Subtype that gives further details of the problem within the assigned Type
   These tags are used to further assign tickets to appropriate teams for resolution. Since thousands of tickets are received by the support team on a daily basis manual classification takes huge effort. It is also error-prone since problem description text is often incomplete and inaccurate with spelling and grammatical errors. The business use case for Ticket classification is to automate the manual effort of assigning Category, Type, and Subtype to each problem description.

Labeled data of 30000 customer tickets is made available for data analysis. After pre-processing 26000 data samples are obtained. The data contained 2, 22 and 89 labels of Category, Type and Subtype respectively which are of categorical data type whereas attribute description is of type text. This problem is mapped as multi-class text classification, as there is a hierarchical relationship between the Category, Type and Subtype. The ML problem is modeled as a learning feature named TicketClassification with training and prediction methods trainModelForTC and makePredictionForTC respectively. Input to the TicketClassification feature is the product feature description and outputs are features category, type and subType from the Ticket feature. The three ML models are named categoryModel, typeModel and subTypeModel.

Samples from the generated Python code for ticket classification are shown below with APIs trainModel and prediction that call methods

```
trainModelForTC and makePredictionForTC respectively from class
TicketClassification.
    #Generated API for TicketClassification
  @app.route(’/train Model’, methods=[″POST″,″GET″])
  def trainModel( ):
    .....
    trainObj=TicketClassification( )
    accuracy_list=trainObj.trainModelForTC(dataTableName,description,c
    ategory,type,subType)
    .....
    .....
  @app.route(’/prediction’, methods=[’GET’, ’POST’])
  def prediction( ):
    .....
    description=data[’description’]
    predictObj=TicketClassification( )
    prediction=predictObj.makePredictionForTC(description)
    .....
  #Generated Code For TicketClassification
    Learning Feature
  class TicketClassification:
    def trainModelForTC(dataTableName,
  description,category,type,subType):
      .....
      .....
    def makePredictionForTC(description_text):
      .....
      .....
      with open(’./description_vectorizer.pkl’, ’rb’) as f:
        vectorizer_description = pickle.
          load(f)
      with open(’./category_encoder.pkl’, ’rb’) as f:
        encoder_category = pickle.load(f)
      with open(’./type_encoder.pkl’, ’rb’)as f:
        encoder_type = pickle.load(f)
      .....
```

The generated data retrieval query fetched the four specified input-output data attributes from the Ticket database table for training. Several ML models were trained and compared them on the basis of F1 scores. Table 1 shows the F1 scores for the three models for the problem ticket classification for each of the techniques. The F1 scores are generated by the Train API. Finally Random Forest is chosen for each of the three models as it gives better performance than others.

TABLE 1

| | F1 score | | | | | |
|---|---|---|---|---|---|---|
| | Category Model | | Type Model | | Subtype Model | |
| Model | Train | Test | Train | Test | Train | Test |
| Random Forest | 0.95 | 0.87 | 0.97 | 0.87 | 0.93 | 0.66 |
| Logistic Regression | 0.88 | 0.89 | 0.90 | 0.89 | 0.60 | 0.57 |
| KNN | 0.88 | 0.85 | 0.88 | 0.85 | 0.73 | 0.61 |
| SVM | 0.94 | 0.90 | 0.93 | 0.89 | 0.57 | 0.56 |
| XGBoost | 0.91 | 0.88 | 0.95 | 0.88 | 0.87 | 0.68 |

The embodiments of present disclosure herein address unresolved problem of integrating ML component development in software product. The disclosure presents a feature-model based method and system for integrating ML development into software product from the requirements stage. This method includes auto-generation of ML code from specifications to make ML development more accessible for product engineering teams and also enable configurability of ML solutions through its lifetime. The disclosed method utilizes ML meta-model which includes process steps involved in the ML process and several techniques used for these steps. The disclosed method integrates the ML meta-model with product feature model of the software product.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method comprising:
receiving, via one or more hardware processors, a set of machine learning (ML) model requirements for solving a ML problem associated with a software product defined using a product feature model, wherein the set of ML model requirements includes a set of input data features, a set of output data features, and a containing feature from the product feature model;
creating, via the one or more hardware processors, a set of dependencies between the set of ML model requirements and a plurality of product features encapsulated into a learning feature to be associated with a ML meta-model;
creating, via the one or more hardware processors, one or more ML model instances utilizing the ML meta-model comprising a set of techniques for each step amongst a set of steps of an ML process, wherein the set of steps comprising a preprocessing, a model training, a prediction, an optimization, a performance metric evaluation, and a visualization;
generating, via the one or more hardware processors, one or more ML software codes utilizing the one or more ML model instances, wherein each of the one or more ML software code is generated using a code template comprising a fixed data and a variable data;
generating, via the one or more hardware processors, one or more training application programming interfaces (APIs) and one or more prediction APIs for calling the one or more ML software codes using an API generation tool;
extracting, via the one or more hardware processors, an input data associated with the set of input data features and an output data associated with the set of output data features from a plurality of data sources corresponding to the software product;
generating, via the one or more hardware processors, one or more ML models by performing a training process and a testing process, utilizing the one or more training application programming interfaces (APIs), the input data and the output data, wherein each of the one or more ML model is associated with a performance metric score;
obtaining, via the one or more hardware processors, a final ML model from the one or more ML models by comparing the performance metric score of each ML model; and
integrating, via the one or more hardware processors, the final ML model with the software product by inserting a prediction API associated with the final ML model, wherein the prediction API is within the containing feature.

2. The processor implemented method of claim 1, wherein the product feature model captures a plurality of functions of the software product as a plurality of product features.

3. The processor implemented method of claim 1, wherein the set of dependencies are dynamically updated during at least one of (i) updates in the set of ML model requirements, and (ii) updates in the plurality of product features.

4. The processor implemented method of claim 1, wherein the set of dependencies are used to validate the set of ML model requirements and the plurality of product features during configuration of the software product.

5. The processor implemented method of claim 1, wherein the containing feature comprises deployment data for the learning feature providing at least one product feature amongst the plurality of product features where the final ML model is to be deployed.

6. The processor implemented method of claim 1, wherein
the fixed data includes a set of import libraries comprising pandas, numpy, scikit-learn and code for pre-processing, and
the variable data includes data from the one or more ML model instances.

7. A system comprising:
a memory storing instructions;
one or more communication interfaces; and
one or more hardware processors coupled to the memory via the one or more communication interfaces, wherein the one or more hardware processors are configured by the instructions to:
receive a set of machine learning (ML) model requirements for solving a ML problem associated with a software product defined using a product feature model, wherein the set of ML model requirements includes a set of input data features, a set of output data features, and a containing feature from the product feature model;
create a set of dependencies between the set of ML model requirements and a plurality of product features encapsulated into a learning feature to be associated with a ML meta-model;
create one or more ML model instances utilizing the ML meta-model comprising a set of techniques for each step amongst a set of steps of an ML process, wherein the set of steps comprising a preprocessing, a model training, a prediction, an optimization, a performance metric evaluation, and a visualization;
generate one or more ML software codes utilizing the one or more ML model instances, wherein each of the one or more ML software code is generated using a code template comprising a fixed data and a variable data;
generate one or more training application programming interfaces (APIs) and one or more prediction APIs for calling the one or more ML software codes using an API generation tool;
extract an input data associated with the set of input data features and an output data associated with the set of output data features from a plurality of data sources corresponding to the software product;
generate one or more ML models by performing a training process and a testing process, utilizing the one or more training application programming interfaces (APIs), the input data and the output data, wherein each of the one or more ML model is associated with a performance metric score;
obtain a final ML model from the one or more ML models by comparing the performance metric score of each ML model; and
integrate the final ML model with the software product by inserting a prediction API associated with the final ML model, wherein the prediction API is within the containing feature.

8. The system of claim 7, wherein the product feature model captures a plurality of functions of the software product as a plurality of product features.

9. The system of claim 7, wherein the set of dependencies are dynamically updated during at least one of (i) updates in the set of ML model requirements, and (ii) updates in the plurality of product features.

10. The system of claim 7, wherein the set of dependencies are used to validate the set of ML model requirements and the plurality of product features during configuration of the software product.

11. The system of claim 7, wherein the containing feature comprises deployment data for the learning feature providing at least one product feature amongst the plurality of product features where the final ML model is to be deployed.

12. The system of claim 7, wherein
the fixed data includes a set of import libraries comprising pandas, numpy, scikit-learn and code for pre-processing, and
the variable data includes data from the one or more ML model instances.

13. One or more non-transitory machine-readable information storage mediums comprising one or more instructions which when executed by one or more hardware processors cause:
receiving a set of machine learning (ML) model requirements for solving a ML problem associated with a software product defined using a product feature model, wherein the set of ML model requirements includes a set of input data features, a set of output data features, and a containing feature from the product feature model;
creating a set of dependencies between the set of ML model requirements and a plurality of product features encapsulated into a learning feature to be associated with a ML meta-model;
creating one or more ML model instances utilizing the ML meta-model further comprising a set of techniques for each step amongst a set of steps of an ML process, wherein the set of steps comprising a preprocessing, a model training, a prediction, an optimization, a performance metric evaluation, and a visualization;
generating one or more ML software codes utilizing the one or more ML model instances, wherein each of the one or more ML software code is generated using a code template further comprising a fixed data and a variable data;
generating one or more training application programming interfaces (APIs) and one or more prediction APIs for calling the one or more ML software codes using an API generation tool;
extracting an input data associated with the set of input data features and an output data associated with the set of output data features from a plurality of data sources corresponding to the software product;
generating one or more ML models by performing a training process and a testing process, utilizing the one or more training application programming interfaces (APIs), the input data and the output data, wherein each of the one or more ML model is associated with a performance metric score;
obtaining a final ML model from the one or more ML models by comparing the performance metric score of each ML model; and
integrating the final ML model with the software product by inserting a prediction API associated with the final ML model, wherein the prediction API is within the containing feature.

14. The one or more non-transitory machine-readable information storage mediums of claim 13, wherein the product feature model captures a plurality of functions of the software product as a plurality of product features.

15. The one or more non-transitory machine-readable information storage mediums of claim 13, wherein the set of dependencies are dynamically updated during at least one of (i) updates in the set of ML model requirements, and (ii) updates in the plurality of product features.

16. The one or more non-transitory machine-readable information storage mediums of claim 13, wherein the set of dependencies are used to validate the set of ML model requirements and the plurality of product features during configuration of the software product.

17. The one or more non-transitory machine-readable information storage mediums of claim 13, wherein the containing feature comprises deployment data for the learning feature providing at least one product feature amongst the plurality of product features where the final ML model is to be deployed.

18. The one or more non-transitory machine-readable information storage mediums of claim 13, wherein
the fixed data includes a set of import libraries further comprising pandas, numpy, scikit-learn and code for pre-processing, and
the variable data includes data from the one or more ML model instances.
